(19) United States
(12) Patent Application Publication
(10) Pub. No.: US 2024/0377511 A1
(43) Pub. Date: Nov. 14, 2024

(54) OPTICAL APPARATUS, SYSTEM, MOVING APPARATUS, AND CONTROL METHOD

(71) Applicant: CANON KABUSHIKI KAISHA, Tokyo (JP)

(72) Inventor: MASATSUGU NAKANO, Tochigi (JP)

(21) Appl. No.: 18/617,931

(22) Filed: Mar. 27, 2024

(30) Foreign Application Priority Data
May 12, 2023 (JP) 2023-079331

(51) Int. Cl. G01S 7/481; G01S 17/10; G01S 17/931

(52) U.S. Cl. CPC G01S 7/4814; G01S 7/4816; G01S 7/4817; G01S 17/10; G01S 17/931

(57) ABSTRACT

An optical apparatus includes a deflector configured to deflect illumination light from a light source unit including a first light emitter and a second light emitter to scan an object, a light receiver configured to receive reflected light from the object, and a controller configured to cause, based on information about the light source unit, one of the first light emitter and the second light emitter to perform first illumination and the other of the first light emitter and the second light emitter to perform second illumination. The number of light emissions per a predetermined time is smaller than that in the first illumination.

### BACKGROUND

### Technical Field

One of the aspects of the embodiments relates to an optical apparatus configured to detect a target (object) by receiving reflected light from the illuminated target.

### Description of Related Art

Known as a method of measuring a distance to a target is light detection and ranging (LiDAR) that calculates the distance based on the reception time of reflected light from the illuminated target or the phase of the reflected light. Japanese Patent Laid-Open No. 2022-81030 discloses a configuration for maintaining a illumination light amount and for restraining a foreign matter from being detected as a target in which in a case where the foreign matter that is not the target is irradiated with illumination light from a particular light emitter, by suppressing a light emission amount by the particular light emitter and by causing any other light emitter to generate illumination light. Japanese Patent Laid-Open No. 2021-173663 discloses a configuration for superimposing parts of illumination ranges of a plurality of respective light emitters to increase a measuring distance.

LiDAR is demanded to maximize reception of reflected light from a target by a light receiver to improve the distance measuring accuracy, but the reflected light amount from the target becomes smaller as the target is located at a more distant place. Thus, the light emission intensity and the number of light emissions of a light source are to be increased to measure the distance to a distant target. However, in the configurations of Japanese Patent Laid-Open Nos. 2022-81030 and 2021-173663, the function of each light emitter is fixed, and thus the lifetime of a light source is short and the light source becomes susceptible to failures as the light emission intensity and the number of light emissions of the light source are increased.

### SUMMARY

An optical apparatus according to one aspect of the disclosure includes a deflector configured to deflect illumination light from a light source unit including a first light emitter and a second light emitter to scan an object, a light receiver configured to receive reflected light from the object, and a controller configured to cause, based on information about the light source unit, one of the first light emitter and the second light emitter to perform first illumination and the other of the first light emitter and the second light emitter to perform second illumination. The number of light emissions per a predetermined time is smaller than that in the first illumination. A system and a movable apparatus each having the above optical apparatus also constitutes another aspect of the disclosure. A control method corresponding to the above optical apparatus also constitutes another aspect of the disclosure.

Further features of the disclosure will become apparent from the following description of embodiments with reference to the attached drawings.

### BRIEF DESCRIPTION OF THE DRAWINGS

FIG. 1 is a block diagram of principal part of an optical apparatus according to Example 1.

FIG. 2 is a schematic diagram illustrating a typical semiconductor laser and an emitted light beam.

FIGS. 3A, 3B, 3C, and 3D illustrate examples of illumination patterns of the optical apparatus according to Example 1.

FIG. 4 is a block diagram of principal part of an optical apparatus according to Example 2.

FIGS. 5A, 5B, and 5C illustrate an illumination method and a light reception method of the optical apparatus according to Example 2.

FIGS. 6A, 6B, 6C, and 6D illustrate examples of illumination patterns of the optical apparatus according to Example 2.

FIGS. 7A and 7B are block diagrams of principal part of an optical apparatus according to Example 3.

FIGS. 8A and 8B illustrate examples of illumination patterns of the optical apparatus according to Example 3.

FIG. 9 is a block diagram of an on-board (in-vehicle) system according to this embodiment.

FIG. 10 is a schematic diagram of a vehicle (movable apparatus) according to this embodiment.

FIG. 11 is a flowchart illustrating an example of operation of the on-board system according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

An optical apparatus (distance measuring apparatus) using LiDAR includes an illumination system configured to illuminate an target (object) and a light receiving system configured to receive reflected light and scattered light from the target. LiDAR is classified into a coaxial system in which the optical axes of the illumination system and the light receiving system partially match each other and a noncoaxial system in which these optical axes do not match each other. An optical apparatus according to this embodiment is suitable for LiDAR with a coaxial system but also applicable to LiDAR with a noncoaxial system.

An optical apparatus according to each example is used as, for example, an automatic driving support system on a vehicle such as an automobile. The target is, for example, a pedestrian, an obstacle, or a vehicle and separated by about 1 to 300 m. The optical apparatus according to each example measures the distance to the target, and the direction and speed of the vehicle are controlled based on the measurement result.

### Example 1

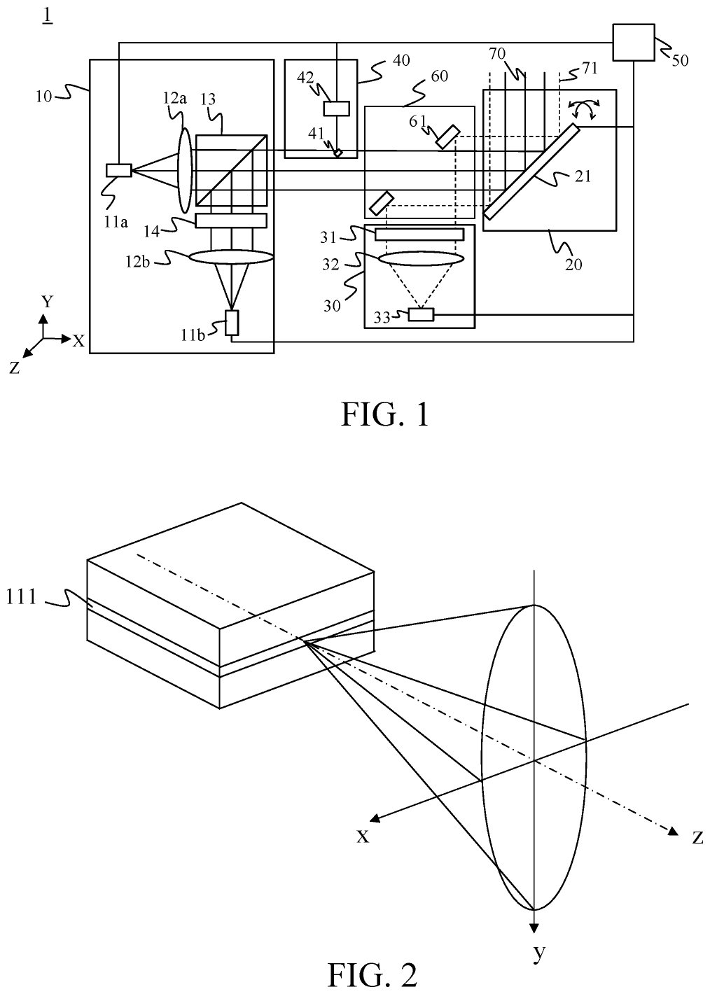

FIG. 1 is a block diagram (schematic diagram) of principal part of an optical apparatus 1 according to this example when viewed from a side. The optical apparatus 1 includes a light source unit 10, a deflector 20, a light receiver 30, a measurement unit 40, a controller 50, and a bifurcation unit 60. FIG. 1 illustrates an optical path (illumination optical path) 70 of illumination light toward the target (object) and an optical path (light receiving optical path) 71 of reflected light from the target toward the light receiver 30.

A coordinate system in this example is determined as illustrated in FIG. 1. More specifically, an X-axis is set to an axis parallel to a direction in which light travels from the light source unit 10, a Y-axis is set to an axis orthogonal to the X-axis and parallel to a direction from the bifurcation unit 60 to the light receiver 30, and a Z-axis is set to an axis orthogonal to the X-axis and the Y-axis.

The optical apparatus 1 can be used as a detection apparatus (image pickup apparatus) configured to detect (capture) the target or a distance measuring apparatus configured to acquire the distance (distance information) to the target, by receiving the reflected light from the target. The optical apparatus 1 employs the LiDAR technology of calculating the distance to the target based on the reception time of reflected light from the target or the phase of the reflected light. LiDAR in this example is a coaxial system in which the optical axes of an illumination system and a light receiving system partially match each other.

The light source unit 10 includes light sources 11a and 11b, and lenses 12a and 12b that collimate illumination light from the light sources 11a and 11b. In this example, one of the light sources 11a and 11b functions as a first light emitter, and the other of them functions as a second light emitter. The light sources 11a and 11b are, for example, semiconductor lasers having high energy concentration and high directionality. Alternatively, the light sources 11a and 11b may be vertical resonator surface light emitting lasers or vertical cavity surface emitting lasers (VCSEL). In a case where the optical apparatus 1 is applied to an on-board system as described below, the target may include a human. Thus, light sources configured to emit infrared light, which has less influence on human eyes, may be employed as the light sources 11a and 11b. In this example, the wavelength of illumination light emitted from each light source 11 is 905 nm, which is included in a near-infrared region.

FIG. 2 is a schematic diagram illustrating a typical semiconductor laser and an emitted light beam. As illustrated in FIG. 2, a light beam emitted from the active layer of a semiconductor laser as the light sources 11a and 11b is a divergent light beam and has an elliptical shape at an xy section parallel to a light emission area (emission surface) 111 of the active layer. In a semiconductor laser, the polarization direction (oscillation direction of an electric field) of a light beam is typically a direction (direction in a zx section) parallel to upper and lower surfaces of the light emission area 111, and the divergence angle in the direction is smaller than that in a direction in a zy section.

Divergent light (illumination light) emitted from each light source is collimated into parallel light through the corresponding lens 12. The parallel light includes not only perfectly parallel light beams but also weakly divergent light and weakly convergent light.

The light source unit 10 includes a coupling element (coupler) 13 for multiplexing illumination light from the light source 11a and illumination light from the light source 11b. The coupling element 13 is, for example, a half-mirror or a polarization beam splitter (PBS). In this example, the coupling element 13 is a PBS. The light source unit 10 also includes a waveplate 14 for changing the polarization state of illumination light from the light source 11b. The waveplate 14 may be a half waveplate.

The light source 11a is disposed such that the x-axis in FIG. 2 matches the Y-axis in FIG. 1 and the y-axis in FIG. 2 matches the Z-axis in FIG. 1. Due to this disposition, illumination light from the light source 11a is polarized in the Y-axis direction and incident as P-polarized light on a bifurcation surface of the coupling element 13. As a result, most of the light transmits through the bifurcation surface, is emitted from the light source unit 10, and travels to the deflector 20.

The light source 11b is disposed such that the x-axis in FIG. 2 matches the X-axis in FIG. 1 and the y-axis in FIG. 2 matches the Z-axis in FIG. 1. Due to this disposition, illumination light from the light source 11b is polarized in the X-axis direction. The illumination light from the light source 11b is collimated through the lens 12b, subjected to phase transition at the waveplate 14, and then incident on the coupling element 13. In a case where the waveplate 14 is a half waveplate, in particular, the illumination light is incident as S-polarized light on the bifurcation surface of the coupling element 13. As a result, most of the light is reflected at the bifurcation surface, is emitted from the light source unit 10, and travels to the deflector 20.

The deflector 20 includes a scanning element 21. The scanning element 21 has a rotational axis parallel to the Y-axis direction and a rotational axis parallel to the Z-axis direction and scans the target with illumination light traveling in the positive X-axis direction from the light source unit 10. The scanning element 21 also deflects and guides reflected light from the target to the light receiver 30. The scanning element 21 may be a micro electro mechanical system (MEMS) mirror or the like.

The light receiver 30 includes an optical filter 31, a condenser lens 32, and a light receiving element 33. The optical filter 31 is a member for allowing desired light to pass and shielding (absorbing) other unnecessary light, and in this example, is a band-pass filter that transmits light in a wavelength band corresponding to illumination light emitted from the light sources 11a and 11b. The condenser lens 32 condenses reflected light from the scanning element 21 onto a light receiving surface of the light receiving element 33. The configurations of the optical filter 31 and the condenser lens 32 are not limited to those in this example. For example, the component materials may be disposed in the opposite order or a plurality of component materials of each kind may be disposed, as necessary. Reflected light from the target illuminated with illumination light is deflected by the scanning element 21, passes through the optical filter 31, and then is condensed through the condenser lens 32 and incident on the light receiving element 33. The light receiving element 33 is an element (sensor) for receiving light from the condenser lens 32, photoelectrically converting the light, and outputting a signal. The light receiving element 33 may be configured by, for example, a photo diode (PD), an avalanche photo diode (APD), or a single photon avalanche diode (SPAD).

The bifurcation unit (branching unit) 60 bifurcates (branches) a path into the illumination optical path 70 and the light receiving optical path 71, guides illumination light to the deflector 20, and guides reflected light from the deflector 20 to the light receiver 30. The bifurcation unit 60 includes a bifurcation element 61. In the bifurcation element 61, a through-hole is formed in a range through which illumination light passes, and a reflector is provided in a range through which reflected light from the target passes. The reflector is configured by a reflective film (reflective layer) made of, for example, metal or dielectric. The illumination light passes through the through-hole of the bifurcation element 61 and is guided to the deflector 20, and reflected light from the target is reflected by the deflector 20, then reflected by the reflector of the bifurcation element 61, and guided to the light receiver 30.

The measurement unit 40 measures light emission states of the light sources 11a and 11b. The measurement unit 40 includes a reflection element 41 for taking out part of illumination light, and a light receiving element 42 for receiving the illumination light taken out (light reflected by the reflection element 41).

The controller 50 is a processing unit (at least one processor) such as a central processing unit (CPU) or is a calculator (computer) including the processing device, and controls the light sources 11a and 11b, the scanning element 21, the light receiving element 33, the light receiving element 42, and the like. More specifically, the controller 50 controls each of the light sources 11a and 11b, the scanning element 21, the light receiving element 33, and the light receiving element 42 to drive with a predetermined driving voltage and a predetermined driving frequency. For example, the controller 50 controls the light sources 11a and 11b to generate pulsed light of illumination light and modulate the intensity of illumination light, thereby generating signal light.

The controller 50 acquires distance information about the target based on a period from when (light emission time) at which illumination light is emitted to when (light reception time) at which reflected light is received by the light receiving element 33. In this case, the controller 50 may acquire a signal from the light receiving element 33 at a particular frequency. The controller 50 may acquire the distance information about the target based on the phase of reflected light instead of the time from emission of illumination light to reception of reflected light. More specifically, the controller 50 may acquire the distance information about the target by calculating a difference (phase difference) between the phase of a signal from the light sources 11a and 11b and the phase of a signal output from the light receiving element 33 and multiplying the calculated phase difference by the light speed.

The controller 50 can switch the light emission timing and the number of light emissions from each of the light sources 11a and 11b according to the received light amount by the light receiving element 42.

The controller 50 causes, in accordance with information about the light source unit 10, one of the first and second light emitters to perform first illumination and the other of the first and second light emitters to perform second illumination having the number of light emissions for a predetermined time smaller than that of the first illumination. That the number of light emissions in the first illumination is larger than the number of light emissions in the second illumination means that the number of illumination spots (unit illumination areas) in the first illumination is larger than the number of illumination spots in the second illumination. The information about the light source unit 10 is, for example, the number of light emissions by the light emitter that performs the first illumination. In this case, the controller 50 switches the light emitter that performs the first illumination and the light emitter that performs the second illumination in a case where the number of light emissions by the light emitter that performs the first illumination is equal to or larger than a predetermined value. Alternatively, the information about the light source unit 10 is, for example, the temperature of the light emitter that performs the first illumination. In this case, the controller 50 switches the light emitter that performs the first illumination and the light emitter that performs the second illumination in a case where the temperature of the light emitter that performs the first illumination is equal to or higher than a predetermined value. In a case where the first light emitter and the second light emitter are provided to a single light source as in Example 2 to be described below, the temperature of the light source may be regard as the temperature of the light emitter that performs the first illumination. The information about the light source unit 10 is, for example, a change amount of light emission intensity for a predetermined wavelength of the illumination light. As described below, a heat generation state of the light source can be estimated based on a change of light emission intensity. In this case, the controller 50 switches the light emitter that performs the first illumination and the light emitter that performs the second illumination in a case where the change amount of the light emission intensity for the predetermined wavelength of the illumination light is equal to or larger than a predetermined value.

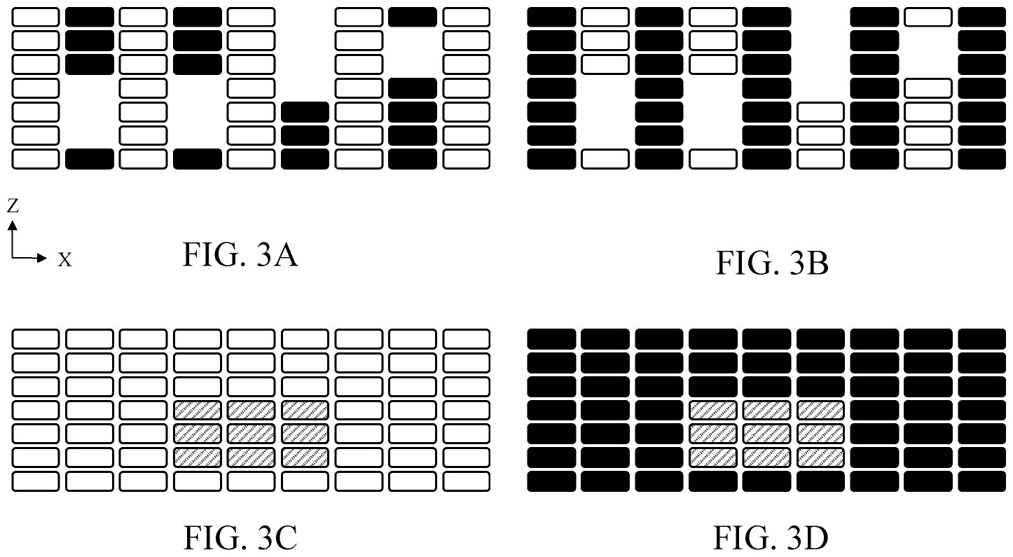

FIGS. 3A, 3B, 3C, and 3D illustrate examples of illumination patterns of the optical apparatus 1 according to this example. In FIGS. 3A, 3B, 3C, and 3D, illumination spots of illumination light from the light source 11a are illustrated in white, and illumination spots of illumination light from the light source 11b are illustrated in black. A range illuminated with illumination light from the light sources 11a and 11b is hatched with oblique lines.

FIG. 3A illustrates an illumination pattern at a predetermined timing. A first illumination range is an illumination range of illumination light from the light source 11a, and a second illumination range is an illumination range of illumination light from the light source 11b. In FIG. 3A, the first illumination is illumination by the light source 11a, the second illumination is illumination by the light source 11b, and the number of illumination spots included in the first illumination range is smaller than the number of illumination spots included in the second illumination range. In other words, the light source 11b has the number of light emissions smaller than that of the light source 11a. In FIG. 3A, the second illumination range is used for high resolution in a predetermined area.

In FIG. 3A, the light source 11a has the number of light emissions larger than that of the light source 11b, and accordingly, is likely to reach its lifetime earlier or fail due to temperature rise along with heat generation. Accordingly, this example switches (turns) the functions of the light sources 11a and 11b as appropriate to suppress lifetime reduction and failure likelihood of one of the light sources. More specifically, the number of light emissions by each of the light sources 11a and 11b is counted by using part of the illumination light taken out by the measurement unit 40, and the controller 50 switches the functions of the light sources 11a and 11b in accordance with the number of light emissions of the light sources 11a and 11b. More specifically, the controller 50 switches the functions of the light sources 11a and 11b in a case where the number of light emissions by a light source having an illumination range that is the first illumination range (performing the first illumination) is equal to or larger than a predetermined value. The controller 50 may switch the functions of the light sources 11a and 11b using another method. For example, the light receiving element 42 may be provided with filters having different transmission ratios for wavelengths. A light source has a characteristic where the wavelength changes as temperature changes, and thus a light amount change means a wavelength change, and as a result, a heat generation state of the light source can be estimated. The controller 50 switches the functions of the light sources 11a and 11b in a case where one of the light sources excessively generates heat.

FIG. 3B illustrates an illumination pattern when the controller 50 switches the functions of the light sources 11a and 11b from the state in FIG. 3A. Since LiDAR in this example is a coaxial system, the illumination pattern in FIG. 3A can be switched to the illumination pattern in FIG. 3B by changing the light emission timings and the number of light emissions of the light sources 11a and 11b through the controller 50. In FIG. 3B, the first illumination is illumination using the light source 11b, the second illumination is illumination using the light source 11a, the first illumination range is an illumination range of illumination light from the light source 11b, and the second illumination range is an illumination range of illumination light from the light source 11a.

FIG. 3C illustrates an illumination pattern different from that of FIG. 3A at a predetermined timing. In FIG. 3C, the first illumination is illumination using the light source 11a, and the second illumination is illumination using the light source 11b. In FIG. 3C, the first illumination range is an illumination range of illumination light from the light source 11a and is the entire illumination range. The second illumination range is a range in which the illumination ranges of illumination light from the light sources 11a and 11b overlap each other. In a case where the light sources 11a and 11b simultaneously emit light, an illumination light amount in a hatched range (where the first illumination range and the second illumination range overlap each other) can be increased, and thus a long distance can be measured by using reflected light from the second illumination range.

FIG. 3D illustrates an illumination pattern when the controller 50 switches the functions of the light sources 11a and 11b from the state in FIG. 3C in accordance with a measurement result by the measurement unit 40. In FIG. 3D, the first illumination is illumination using the light source 11b, and the second illumination is illumination using the light source 11a. The first illumination range is an illumination range of the illumination light from the light source 11b, and the second illumination range is an illumination range of the illumination lights from the light sources 11a and 11b.

As described above, the configuration according to this example can extend lifespans of the light sources and improve the distance measuring function.

### Example 2

This example will discuss a configuration different from that of Example 1, and omit a description of a common configuration.

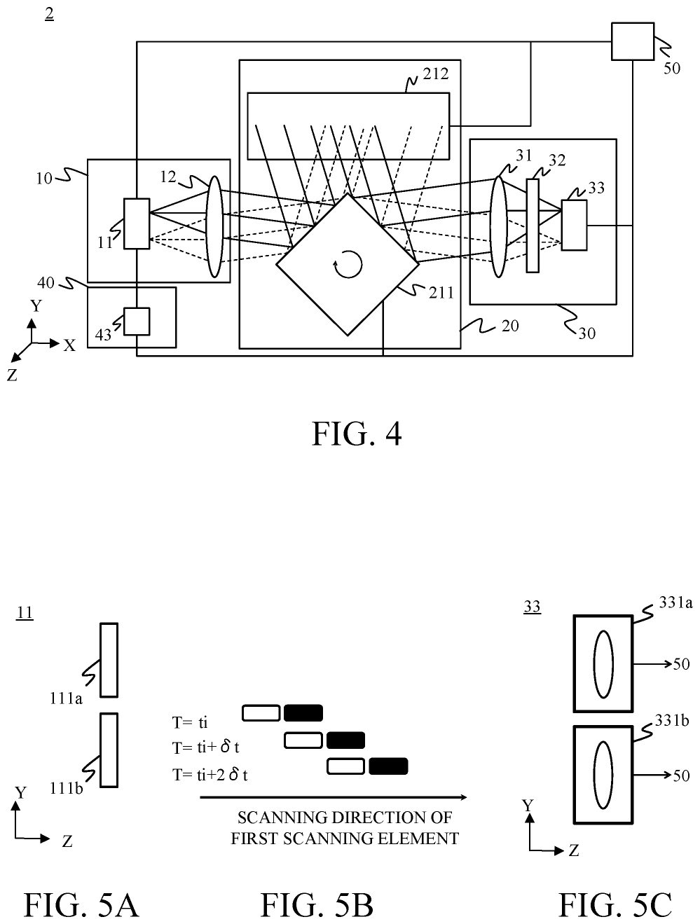

FIG. 4 is a block diagram (schematic diagram) of a principal part of an optical apparatus 2 according to this example when viewed from front. The optical apparatus 2 includes the light source unit 10, the deflector 20, the light receiver 30, the measurement unit 40, and the controller 50.

FIG. 5A illustrates a light source 11 according to this example. A single light emission area in which a laser beam is emitted is provided for each light source in Example 1, but this example provides two light emission areas (light emission areas 111a and 111b) in the Y-axis direction. In this example, one of the light emission areas 111a and 111b functions as the first light emitter, and the other functions as the second light emitter.

The deflector 20 includes a first scanning element 211 and a second scanning element 212. The first scanning element 211 has a rotational axis parallel to the Z-axis direction, deflects and guides, to the second scanning element 212, illumination light traveling in the positive X-axis direction from the light source unit 10, and guides reflected light from the second scanning element 212 to the light receiver 30. Thereby, the target can be scanned in the X-axis direction. In this example, the first scanning element 211 uses a polygon mirror having four reflective surfaces. The second scanning element 212 has a rotational axis parallel to the X-axis direction, scans the target with illumination light from the first scanning element 211, and deflects and guides to the first scanning element 211, reflected light from the target. Thereby, the target can be scanned in the Y-axis direction. In other words, a distance can be measured in a wide range using the two scanning elements since the target is scanned in the X-axis direction using the first scanning element 211 and in the Y-axis direction using the second scanning element 212.

The light receiving element 33 includes a plurality of pixels. Each pixel receives reflected light from the target illuminated by a corresponding light emission area and outputs a signal to the controller 50.

The measurement unit 40 includes a temperature measurement element 43. The light source 11 generates heat in accordance with the number of light emissions and outputs. The temperature measurement element 43 measures the temperature (heat generation state) of the light source 11 and outputs a measurement result to the controller 50. The controller 50 switches the functions of the light emission areas when the temperature of the light source 11 becomes high as described below.

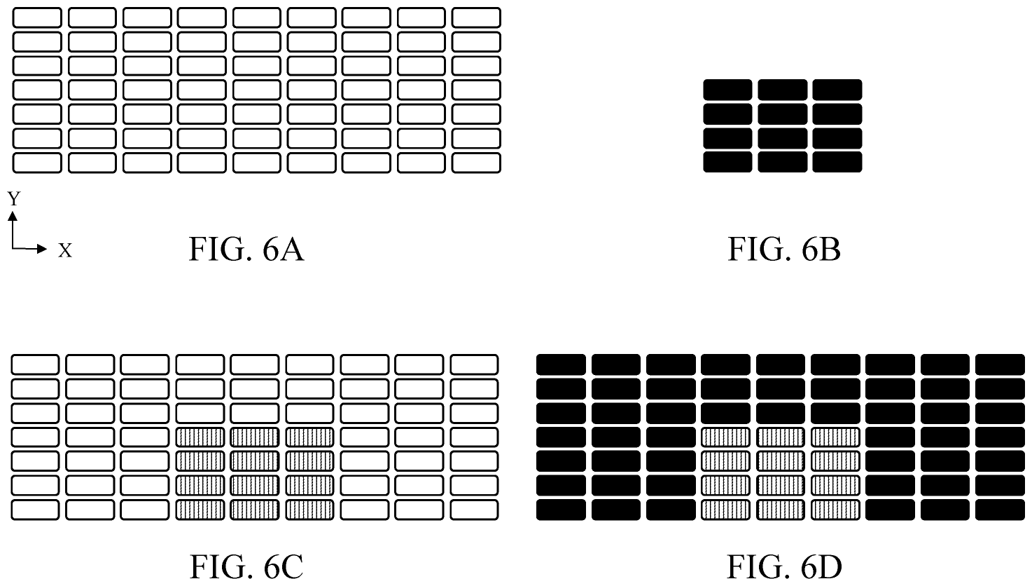

FIGS. 6A, 6B, 6C, and 6D illustrate examples of illumination patterns of the optical apparatus 1 according to this example. FIGS. 6A, 6B, 6C, and 6D illustrate illumination patterns of illumination light from the light emission area 111a in white, and illumination patterns of illumination light from the light emission area 111b in black. A range illuminated with illumination light from the light emission areas 111a and 111b is hatched with vertical lines.

FIGS. 6A and 6B illustrate the illumination patterns of illumination light from the light emission area 111a and the illumination patterns of illumination light from the light emission area 111b, respectively, at a predetermined timing. In FIGS. 6A and 6B, the number of illumination patterns of illumination light from the light emission area 111a is smaller than that of illumination light from the light emission area 111b. Thus, the number of light emissions in the light emission area 111b is smaller than that in the light emission area 111a.

FIG. 6C illustrates the illumination pattern of illumination light from the light emission area 111a in FIG. 6A and the illumination pattern of illumination light from the light emission area 111b in FIG. 6B in an overlapping manner. In FIG. 6C, the first illumination is illumination using the light emission area 111a, and the second illumination is illumination using the light emission area 111b. The first illumination range is an illumination range of illumination light from the light emission area 111a and is the entire illumination range. The second illumination range is a range in which the illumination ranges of illumination light from the light emission areas 111a and 111b overlap each other. However, the second illumination range is illuminated at different timings by illumination light from the light emission area 111a and illumination light from the light emission area 111b.

A description will now be given of illumination of the second illumination range with illumination lights from the light emission areas 111a and 111b. FIG. 5B illustrates a relationship between a light emission timing and a position of each illumination spot. In this example, the first scanning element 211 has a scanning speed higher than that of the second scanning element 212. At time T of ti, the illumination spot of the light emission area 111b precedes the illumination spot of the light emission area 111a in the scanning direction by the first scanning element 211. At time T of ti+δt, the illumination spot of the light emission area 111b precedes the illumination spot of the light emission area 111a in the scanning direction by the first scanning element 211. The illumination spot of the light emission area 111a is located at a position of the illumination spot of the light emission area 111b at time T of ti. At time T of ti+2δt, the illumination spot of the light emission area 111b precedes the illumination spot of the light emission area 111a in the scanning direction by the first scanning element 211. The illumination spot of the light emission area 111a is located at a position of the illumination spot of the light emission area 111b at time T of ti+δt. Thus, the same position can be illuminated with a slight time lag. As a result, two distance measurement results can be used, and thus distance measuring accuracy can be improved.

FIG. 6D illustrates an illumination pattern when the controller 50 switches the functions of the light emission areas 111a and 111b from the state in FIG. 6C in accordance with a measurement result by the measurement unit 40. In FIG. 6D, the first illumination is illumination using the light emission area 111b, and the second illumination is illumination using the light emission area 111a. The first illumination range is an illumination range of illumination light from the light emission area 111b, and the second illumination range is a range in which the illumination ranges of illumination light from the light emission areas 111a and 111b overlap each other.

FIG. 5C illustrates the configuration of the light receiving element 33. The light receiving element 33 has light receiving areas 331a and 331b provided in the same direction as the arrangement direction of the light emission areas 111a and 111b. The illumination light from the light emission area 111a is reflected by the target, and the reflected light from the target is received by the light receiving area 331a. The illumination light from the light emission area 111b is reflected by the target, and the reflected light from the target is received by the light receiving area 331b.

As described above, the configuration according to this example can extend lifespans of the light sources and improve the distance measuring function.

### Example 3

This example will discuss a configuration different from that of Example 1, and omit a description of a common configuration.

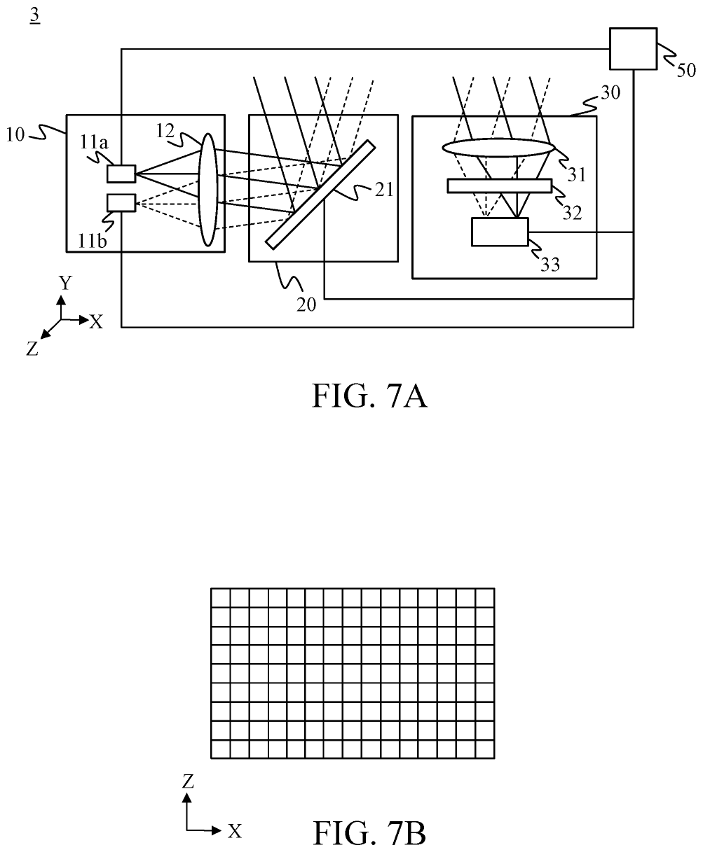

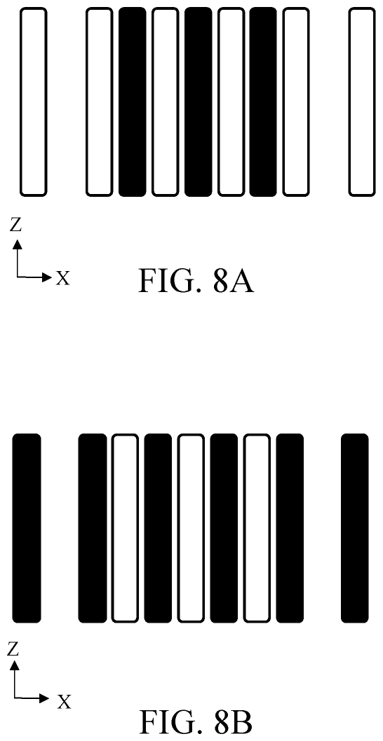

FIG. 7A is a block diagram (schematic diagram) of a principal part of an optical apparatus 3 according to this example when viewed from a side. The optical apparatus 2 includes the light source unit 10, the deflector 20, the light receiver 30, and the controller 50. LiDAR in this example is a noncoaxial system in which the optical axes of an illumination system and a light receiving system do not match each other.

The light source unit 10 includes the two light sources 11a and 11b and a lens 12 that collimates illumination light from the light sources 11a and 11b. In this example, one of the light sources 11a and 11b functions as the first light emitter, and the other of the light sources 11a and 11b functions as the second light emitter. The light sources 11a and 11b are disposed such that the x-axis in FIG. 2 matches the Z-axis in FIG. 7A and the y-axis in FIG. 2 matches the Y-axis in FIG. 1. The lens 12 is a cylindrical lens having optical power only in one direction. The lens 12 is not limited to a cylindrical lens but may be another optical element such as a diffractive lens. In this example, the lens 12 has power only about the Z-axis. Thereby, illumination lights from the light sources 11a and 11b are collimated only in the Y-axis direction but left diverging in the Z-axis direction.

The scanning element 21 has a rotational axis parallel to the Z-axis direction. Since the illumination lights from the light sources 11a and 11b are collimated only in the Y-axis direction as described above, two-dimensional illumination can be performed through scanning in the X-axis direction by the scanning element 21. Since LiDAR in this example is a noncoaxial system, a plurality of light receiving elements 33 are to be two-dimensionally arranged as illustrated in FIG. 7B and each of them receives reflected light from the deflector 20. The light receiving elements that receive reflected light from the deflector 20 differ in accordance with an angle of the deflector 20.

FIGS. 8A and 8B illustrate illumination patterns of the optical apparatus 3 in this example. FIGS. 8A and 8B illustrate illumination spots of the illumination light from the light source 11a in white, and illumination spots of the illumination light from the light source 11b in black.

FIG. 8A illustrates an illumination pattern at a predetermined timing. In FIG. 8B, the first illumination is illumination using the light source 11a, and the second illumination is illumination using the light source 11b. FIG. 8B illustrates an illumination pattern when the functions of the light sources 11a and 11b are switched from the state in FIG. 8A. Similarly to Example 2, the spatially same position can be illuminated at slightly different illumination timings. In FIG. 8B, the first illumination is illumination using the light source 11b, and the second illumination is illumination using the light source 11a.

This example provides no measurement unit to measure the states of the light sources 11a and 11b, and the controller 50 counts the number of light emissions of the light sources 11a and 11b and switches the functions of the light sources 11a and 11b in a case where the number of light emissions is equal to or larger than a predetermined value. Since no measurement unit is provided, the number of components can be reduced.

The controller 50 may perform control such that the light amount of a light source that forms the first illumination range is different from the light amount of a light source that forms the second illumination range. For example, in FIG. 8A, the light amount of the light source 11b may be controlled to be larger than the light amount of the light source 11a. Thereby, a long distance can be measured by using the second illumination range and the lifespans of the light sources can be extended because the number of light emissions is reduced.

As described above, the configuration according to this example can extend lifespans of the light sources and improve the distance measuring function.

### On-Board System (In-Vehicle System)

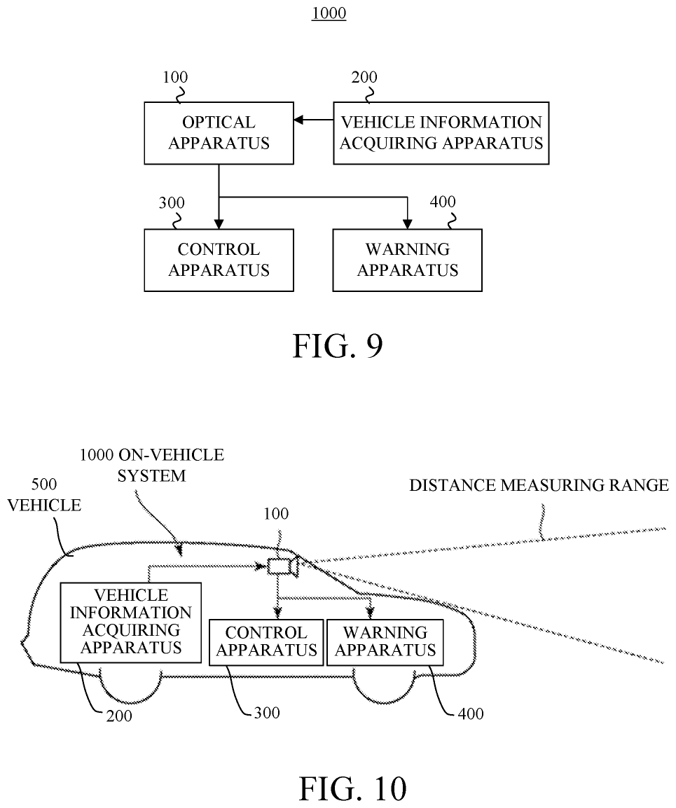

FIG. 9 is a configuration diagram of an optical apparatus 100 according to this example, and an on-board system (driving support apparatus) 1000 having the same. The optical apparatus 100 includes any one of the optical apparatuses 1, 2, and 3 according to Examples 1, 2, and 3. The on-board system 1000 is an apparatus held by a movable body (movable apparatus) such as an automobile (vehicle), and configured to support driving (steering) of the vehicle based on distance information on a target such as an obstacle or a pedestrian around the vehicle acquired by the optical apparatus 100. FIG. 10 is a schematic diagram of a vehicle 500 including the on-board system 1000. FIG. 10 illustrates a case where the distance measuring range (detecting range) of the optical apparatus 100 is set to the front of the vehicle 500, but the distance measuring range may be set to the rear or side of the vehicle 500.

As illustrated in FIG. 10, the on-board system 1000 includes the optical apparatus 100, a vehicle information acquiring apparatus 200, a control apparatus (ECU: electronic control unit) 300, and a warning apparatus (warning unit) 400. In the on-board system 1000, the controller 50 included in the optical apparatus 100 has functions of a distance acquiring unit (acquiring unit) and a collision determining unit (determining unit). However, if necessary, the on-board system 1000 may include a distance acquiring unit and a collision determining unit separate from the controller 50, or these components may be provided outside of the optical apparatus 100 (for example, inside the vehicle 500). Alternatively, the control apparatus 300 may be used as the controller 50.

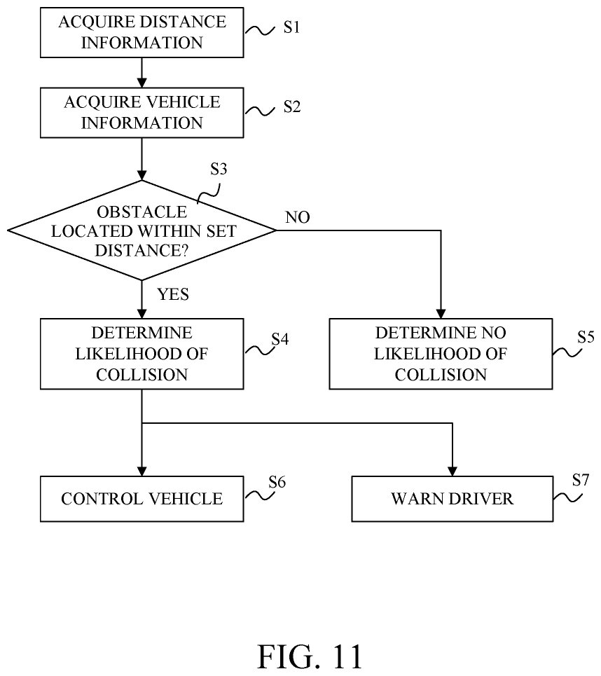

FIG. 11 is a flowchart illustrating an operation example of the on-board system 1000 according to this example. A description will now be given of the operation of the on-board system 1000 with reference to this flowchart.

First, in step S1, the light source unit in the optical apparatus 100 illuminates a target around the vehicle, and the controller 50 acquires the distance information on the target based on the signal output from the light receiver by receiving the reflected light from the target. In step S2, the vehicle information acquiring apparatus 200 acquires vehicle information including the speed, yaw rate, steering angle of the vehicle, and the like. Next, in step S3, the controller 50 determines whether the distance to the target is within a preset distance range using the distance information acquired in step S1 and the vehicle information acquired in step S2.

This configuration can determine whether or not the target exists within the set distance range around the vehicle, and determine whether a collision is likely to occur between the vehicle and the target. Steps S1 and S2 may be performed in the reverse order of the above order or in parallel. The controller 50 determines that the collision is likely in a case where the target exists within the set distance (step S4) and determines that the collision is unlikely in a case where the target does not exist within the set distance (step S5).

Next, in the case where the controller 50 determines that the collision is likely, the controller 50 notifies (transmits) the determination result to the control apparatus 300 and the warning apparatus 400. At this time, the control apparatus 300 controls the vehicle based on the determination result of the controller 50 (step S6), and the warning apparatus 400 warns the user (driver) of the vehicle based on the determination result of the controller 50 (step S7). The determination result may be notified to at least one of the control apparatus 300 and the warning apparatus 400.

The control apparatus 300 can control the vehicle by generating a control signal, for example, to apply the brakes, release the accelerator, turn the steering wheel, and generate braking force at each wheel to suppress the output of the engine or motor. The warning apparatus 400 warns the driver by, for example, emitting a warning sound, displaying warning information on the screen of a car navigation system, or applying vibration to the seat belt or steering wheel.

Thus, the on-board system 1000 according to this example can detect the target and measure the distance to the target by the above processing, and avoid the collision between the vehicle and the target. In particular, applying the optical apparatus according to each of the examples to the on-board system 1000 can realize high distance measuring accuracy, so that target detection and collision determination can be performed with high accuracy.

This example applies the on-board system 1000 to the driving support (collision damage mitigation), but the on-board system 1000 is not limited to this example and is applicable to cruise control (including adaptive cruise control) and automatic driving. The on-board system 1000 is applicable not only to a vehicle such as an automobile but also to a moving body such as a ship, an aircraft, or an industrial robot. It can be applied not only to moving objects but also to various devices that utilize object recognition such as intelligent transportation systems (ITS) and monitoring systems.

The on-board system 1000 and the movable apparatus may include a notification apparatus (notifying unit) for notifying the manufacturer of the on-board system, the seller (dealer) of the movable apparatus, or the like of any collisions between the movable apparatus and the obstacle. For example, the notification apparatus may use an apparatus that transmits information (collision information) on the collision between the movable apparatus and the obstacle to a preset external notification destination by e-mail or the like.

Thus, the configuration for automatically notifying the collision information through the notification apparatus can promote processing such as inspection and repair after the collision. The notification destination of the collision information may be an insurance company, a medical institution, the police, or another arbitrary destination set by the user. The notification apparatus may notify the notification destination of not only the collision information but also the failure information on each component and consumption information on consumables. The presence or absence of the collision may be detected based on the distance information acquired by the output from the above light receiver or by another detector (sensor).

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an optical apparatus that can extend lifespans of light sources and improve distance measuring accuracy.

This application claims priority to Japanese Patent Application No. 2023-079331, which was filed on May 12, 2023, and which is hereby incorporated by reference herein in its entirety.

What is claimed is:

1. An optical apparatus comprising:
a deflector configured to deflect illumination light from a light source unit including a first light emitter and a second light emitter to scan an object;
a light receiver configured to receive reflected light from the object; and
a controller configured to cause, based on information about the light source unit, one of the first light emitter and the second light emitter to perform first illumination and the other of the first light emitter and the second light emitter to perform second illumination,
wherein the number of light emissions per a predetermined time in the second illumination is smaller than that in the first illumination.

2. The optical apparatus according to claim 1, wherein the controller is configured to switch a light emitter that performs the first illumination and a light emitter that performs the second illumination, in a case where the number of light emissions by the one of the first light emitter and the second light emitter that performs the first illumination is equal to or larger than a predetermined value.

3. The optical apparatus according to claim 1, wherein the controller is configured to switch a light emitter that performs the first illumination and a light emitter that performs the second illumination, in a case where temperature of the one of the first light emitter and the second light emitter that performs the first illumination is equal to or higher than a predetermined value.

4. The optical apparatus according to claim 1, wherein the controller is configured to switch a light emitter that performs the first illumination and a light emitter that performs the second illumination, in a case where a change amount of light emission intensity for a predetermined wavelength of the illumination light is equal to or larger than a predetermined value.

5. The optical apparatus according to claim 1, wherein a position of a unit illumination area in the second illumination is different from a position of an illumination spot in the first illumination.

6. The optical apparatus according to claim 1, wherein a position of a unit illumination area in the second illumination overlaps a position of an illumination spot in the first illumination.

7. The optical apparatus according to claim 1, wherein the light receiver includes a plurality of light receiving elements arranged along a predetermined direction.

8. The optical apparatus according to claim 7, wherein the first light emitter and the second light emitter are arranged along the predetermined direction.

9. The optical apparatus according to claim 7, wherein the deflector scans the object in a first direction, and
wherein the light source unit and the light receiver are arranged along a second direction orthogonal to the first direction.

10. The optical apparatus according to claim 1, wherein the light source unit includes a first light source including the first light emitter, a second light source including the second light emitter, and a coupler configured to couple light from the first light source and light from the second light source to each other.

11. The optical apparatus according to claim 1, wherein the deflector rotates about two different axes.

12. The optical apparatus according to claim 1, wherein the controller is configured to control the first light emitter and the second light emitter so that a light emission amount of a light emitter that performs the first illumination is different from a light emission amount of a light emitter that performs the second illumination.

13. The optical apparatus according to claim 1, wherein the controller acquires distance information about the object based on an output from the light receiver.

14. The optical apparatus according to claim 1, wherein the light receiver includes a plurality of light receiving elements configured to receive the reflected light from the deflector, and
wherein the light receiving elements configured to receive the reflected light from the deflector differ according to an angle of the deflector.

15. A system comprising the optical apparatus according to claim 1, wherein the system is configured to determine a likelihood of collision between a movable apparatus and the object based on distance information about the object, which has been obtained by the optical apparatus.

16. The system according to claim 15, further comprising a control apparatus configured to output a control signal that causes the movable apparatus to generate a braking force in a case where it is determined that there is the likelihood of collision between the movable apparatus and the object.

17. The system according to claim 15, further comprising a warning apparatus configured to warn a user of the movable apparatus in a case where it is determined that there is the likelihood of collision between the movable apparatus and the object.

18. A movable apparatus comprising the optical apparatus according to claim 1,
wherein the movable apparatus holds and is movable with the optical apparatus.

19. The movable apparatus according to claim 18, further comprising a determining unit configured to determine a likelihood of collision with the object based on distance information on the object obtained by the optical apparatus.

20. A control method for an optical apparatus including a deflector configured to deflect illumination light from a light source unit including a first light emitter and a second light emitter to scan an object, and a light receiver configured to receive reflected light from the object, the control method comprising the steps of:
causing, based on information about the light source unit, one of the first light emitter and the second light emitter to perform first illumination; and
causing, based on the information, the other of the first light emitter and the second light emitter to perform second illumination having the number of light emissions per a predetermined time smaller than that in the first illumination.
